(19) United States
(12) Patent Application Publication
(10) Pub. No.: US 2024/0347239 A1
(43) Pub. Date: Oct. 17, 2024

(54) Core-Shell Nanodisc Synthesis and Applications to Single-Particle Targeted Magnetothermal Control of Biological Signaling

(71) Applicant: Massachusetts Institute of Technology, Cambridge, MA (US)

(72) Inventors: Polina Olegovna ANIKEEVA, Lexington, MA (US); Ye Ji Kim, Cambridge, MA (US); Florian Koehler, Somerville, MA (US)

(21) Appl. No.: 18/635,476

(22) Filed: Apr. 15, 2024

Related U.S. Application Data
(60) Provisional application No. 63/496,112, filed on Apr. 14, 2023.

(51) Int. Cl. H01F 1/00; H01F 1/06; H01F 1/24

(52) U.S. Cl. CPC H01F 1/0054; H01F 1/0063; H01F 1/061; H01F 1/063; H01F 1/24

(57) ABSTRACT

Anisotropic magnetothermal nanoparticles and methods for making the same are disclosed. The anisotropic magnetothermal nanoparticle may include a core and a shell. The core may include hexagonal nanodisc hematite (Fe₂O₃). The shell may include AₓFe₃₋ₓO₄, where A=Co, Mn, Ni, Fe, Zn, Mg, or Cu. The anisotropic magnetothermal nanoparticle may also include a polymer coating.

### CROSS-REFERENCE TO RELATED PATENT APPLICATION(S)

This patent application claims the priority benefit, under 35 U.S.C. 119(e), of U.S. Application No. 63/496,112, filed Apr. 14, 2023, which is incorporated herein by reference in its entirety for all purposes.

### GOVERNMENT SUPPORT

This invention was made with government support under AT011991 awarded by the National Institutes of Health. The government has certain rights in the invention.

### BACKGROUND

An urgent challenge in the biomedical field is understanding information processing and transfer within the mammalian nervous system. An ever-increasing percentage of our aging population is affected by neurodegenerative, neurological, and psychiatric diseases, including Alzheimer's disease, Parkinson's disease, and major depressive disorders. While neuroscience research to date has significantly advanced our understanding of neural functions, new technologies are needed to link molecular function to behavior and physiology in health and disease. There is a growing demand for minimally invasive, localized perturbation of neural activity at the single-protein resolution. Operating on the scale of proteins, nanomaterial transducers are uniquely poised to enable such minimally invasive neuromodulation.

For contactless communication, optical, acoustic, and magnetic stimuli offer advantages for application-specific neural stimulation and recording. Optical stimulation approaches based on genetically encoded opsins, calcium, and voltage indicators offer fine temporal and spatial resolution. However, they are limited to penetration depths of <7 mm due to the tissue absorbance and scattering. Acoustic waves can have penetration depths that are one to two orders of magnitude larger depending on frequency, but require extra techniques, such as the functional ultrasound probes on aqueous cranial windows, to avoid scattering from the skull and thus cannot be used in moving subjects. Magnetic fields can penetrate deep into biological tissue with little attenuation because biological tissue generally has low magnetic susceptibility. Unfortunately, this low magnetic susceptibility means that relatively strong magnetic fields are needed to stimulate biological tissue directly.

Fortunately, magnetic nanoparticles (MNPs) can be used to transduce relatively weak magnetic fields into bioreadable signals that can modulate the behavior of biological tissue. For instance, MNPs can transduce magnetic fields into heat high enough to open a cellular ion channel. Opening (closing) these ion channels allows (prevents) ions from moving into and out of cell membranes, modulating cell behavior, so modulating the ion channels with MNPs effectively modulates the cells themselves.

However, conventional MNPs tend to exhibit hysteresis when used for magnetothermal modulation of ion channels. Each conventional MNP may generate a small amount of heat. As a result, a large number of conventional MNPs may be required in order to generate enough heat to modulate an ion channel in a single cell. However, a single cell may be limited in the number of targeting particles (e.g., MNPs) it can accept and thus it may be challenging to modulate an ion channel in the cell with conventional MNPs since the number of conventional MNPs required to modulate the ion channel may exceed the number of targeting particles able to be accepted by the cell.

### SUMMARY

Inventive MNPs, which are also called anisotropic magnetothermal nanoparticles, magnetothermal nanodiscs, or core-shell nanodiscs, include magnetite cores surrounded by AₓFe₋₃₋ₓO₄, where x may be any value between 0 and 1, coatings or shells, where A is one of Co, Mn, Ni, Fe, Zn, Mg, or Cu. Each magnetite core has a maximum lateral dimension of about 170 nm to about 550 nm and a maximum thickness of up to 50 nm. The AₓFe₃₋ₓO₄ coating can have a thickness of about 5 nm. Each anisotropic magnetothermal nanoparticle can also include a polymer outer layer disposed on the AₓFe₃₋ₓO₄ coating and having hydrophobic side chains oriented toward the AₓFe₃₋ₓO₄ coating and hydrophilic side chains oriented away from the AₓFe₃₋ₓO₄ coating. An anisotropic magnetothermal nanoparticle can also include a component (e.g., a synthetic O6-benzylguanine (BG) derivative) conjugated with the polymer and enabling formation of a bond with a material pairable with a tag for tissue to be heated with the anisotropic magnetothermal nanoparticle.

Core-shell nanodiscs have several differences and advantages over conventional MNPs. First, core-shell nanodiscs may be anisotropic in shape. Second, core-shell nanodiscs may also have magnetic crystalline anisotropy, which may increase the hysteresis loop area. Third, core-shell nanodiscs may generate more heat than conventional MNPs under a magnetic field due, in part, to their shape anisotropy and their magnetic crystalline anisotropy. For example, a single core-shell nanodisc may be able to generate up to 3,000 times more heat than a conventional MNP for the same applied magnetic field. As a result, fewer core-shell nanodiscs may be required to modulate an ion channel in a single cell. Since a cell is limited in the number of targeting particles (e.g., MNPs) it may accept, reducing the number of targeting particles required to modulate an ion channel of the cell is advantageous.

An anisotropic magnetothermal nanoparticle can be made by forming a magnetite nanodisc via reduction of hexagonal nanodisc hematite, then growing AₓFe₃₋ₓO₄ on the magnetite nanodisc to form the anisotropic magnetothermal nanoparticle, where again A is one of Co, Mn, Ni, Fe, Zn, Mg, or Cu. The magnetite nanodisc has a maximum lateral dimension of about 170 nm to about 550 nm and a maximum thickness of up to about 50 nm. Growing the AₓFe₃₋ₓO₄ on the magnetite nanodisc may include growing a plurality of layers of the AₓFe₃₋ₓO₄ on the magnetite nanodisc and/or growing the AₓFe₃₋ₓO₄ to a thickness of about 3 nm to about 10 nm.

The anisotropic magnetothermal nanoparticle can be coated with a polymer having hydrophobic and hydrophilic side chains. The polymer can be conjugated with a component enabling formation of a bond with a material pairable with a tag for tissue to be heated with magnetothermal nanoparticles. These anisotropic magnetothermal nanoparticles can be dispersed in a biocompatible solvent, e.g., at a concentration of 1-100 mg/ml.

In some aspects, the techniques described herein relate to a method of making an anisotropic magnetothermal nanoparticle, the method including forming a magnetite nanodisc via reduction of hexagonal nanodisc hematite and growing AₓFe₃₋ₓO₄ on the magnetite nanodisc to form the anisotropic magnetothermal nanoparticle, where A is one of Co, Mn, Ni, Fe, Zn, Mg, or Cu.

In some aspects, the techniques described herein relate to a method wherein forming the magnetite nanodisc via reduction of hexagonal nanodisc hematite includes controlling a percentage of water in the reduction.

In some aspects, the techniques described herein relate to a method wherein the percentage of water is 6-9%.

In some aspects, the techniques described herein relate to a method wherein the magnetite nanodisc has a maximum lateral dimension of about 170 nm to about 550 nm, a minimum thickness of at least about 20 nm, and a maximum thickness of up to about 50 nm.

In some aspects, the techniques described herein relate to a method wherein growing the AₓFe₃₋ₓO₄ on the magnetite nanodisc includes growing a plurality of layers of the AₓFe₃₋ₓO₄ on the magnetite nanodisc.

In some aspects, the techniques described herein relate to a method wherein growing the AₓFe₃₋ₓO₄ on the magnetite nanodisc includes growing the AₓFe₃₋ₓO₄ to a thickness of about 3 nm to about 10 nm.

In some aspects, the techniques described herein relate to a method further including coating the anisotropic magnetothermal nanoparticle with a polymer having hydrophobic and hydrophilic side chains.

In some aspects, the techniques described herein relate to a method further including conjugating the polymer with a component enabling formation of a bond with a material pairable with a tag for tissue to be heated with magnetothermal nanoparticles.

In some aspects, the techniques described herein relate to a method wherein the anisotropic magnetothermal nanoparticle is one of a plurality of anisotropic magnetothermal nanoparticles and further including dispersing the plurality of anisotropic magnetothermal nanoparticles in a biocompatible solvent.

In some aspects, the techniques described herein relate to an anisotropic magnetothermal nanoparticle including a magnetite core having a maximum lateral dimension of about 170 nm to about 550 nm, a minimum thickness of at least about 20 nm, and a maximum thickness of up to 50 nm and an AₓFe₃₋ₓO₄ coating on the magnetite core, where A is one of Co, Mn, Ni, Fe, Zn, Mg, or Cu.

In some aspects, the techniques described herein relate to an anisotropic magnetothermal nanoparticle wherein the AₓFe₃₋ₓO₄ coating has a thickness of about 5 nm.

In some aspects, the techniques described herein relate to an anisotropic magnetothermal nanoparticle further including a polymer outer layer disposed on the AₓFe₃₋ₓO₄ coating and having hydrophobic side chains oriented toward the AₓFe₃₋ₓO₄ coating and hydrophilic side chains oriented away from the AₓFe₃₋ₓO₄ coating.

In some aspects, the techniques described herein relate to an anisotropic magnetothermal nanoparticle further including a component conjugated with the polymer outer layer and enabling formation of a bond with a material pairable with a tag for tissue to be heated with the anisotropic magnetothermal nanoparticle.

In some aspects, the techniques described herein relate to an anisotropic magnetothermal nanoparticle wherein A is Co.

In some aspects, the techniques described herein relate to an anisotropic magnetothermal nanoparticle wherein the AₓFe₃₋ₓO₄ coating includes a plurality of layers.

In some aspects, the techniques described herein relate to an anisotropic magnetothermal nanoparticle wherein the plurality of layers including a first layer having a first stoichiometry and a second layer having a second stoichiometry different than the first stoichiometry.

In some aspects, the techniques described herein relate to an anisotropic magnetothermal nanoparticle wherein the magnetite core is hexagonal.

In some aspects, the techniques described herein relate to an anisotropic magnetothermal nanoparticle wherein the anisotropic magnetothermal nanoparticle has a specific loss power of about 1270 to about 1980.

In some aspects, the techniques described herein relate to an anisotropic magnetothermal nanoparticle including a soft magnetic core having an anisotropic shape and a hard magnetic coating on the soft magnetic core providing magnetic crystalline anisotropy via spin-exchange coupling effects at an interface between the soft magnetic core and the hard magnetic coating.

In some aspects, the techniques described herein relate to an anisotropic magnetothermal nanoparticle wherein the anisotropic magnetothermal nanoparticle has a specific loss power of about 1270 to about 1980.

All combinations of the foregoing concepts and additional concepts discussed in greater detail below (provided such concepts are not mutually inconsistent) are contemplated as being part of the inventive subject matter disclosed herein. In particular, all combinations of claimed subject matter appearing at the end of this disclosure are contemplated as being part of the inventive subject matter disclosed herein. Terminology explicitly employed herein that also may appear in any disclosure incorporated by reference should be accorded a meaning most consistent with the particular concepts disclosed herein.

### BRIEF DESCRIPTIONS OF THE DRAWINGS

The skilled artisan will understand that the drawings primarily are for illustrative purposes and are not intended to limit the scope of the inventive subject matter described herein. The drawings are not necessarily to scale; in some instances, various aspects of the inventive subject matter disclosed herein may be shown exaggerated or enlarged in the drawings to facilitate an understanding of different features. In the drawings, like reference characters generally refer to like features (e.g., functionally similar and/or structurally similar elements).

FIG. 1A is an image of a magnetite (Fe₃O₄) nanodisc (MND) core.

FIG. 1B is an image of a core-shell nanodisc made from forming a shell of AₓFe₃₋ₓO₄ on the MND core of FIG. 1A.

FIG. 1C is a drawing of a cross-section of a core-shell nanodisc.

FIG. 1D is a drawing of a cross-section of a shell with multiple layers suitable for use with a core-shell nanodisc (e.g., in the dotted rectangle in FIG. 1C).

FIG. 1E is a drawing of a shell with multiple layers with individual layers having different stoichiometries suitable for use with a core-shell nanodisc (e.g., in the dotted rectangle in FIG. 1C).

FIG. 1F is another image of a cross-section of the shell marked with the dotted square in FIG. 1C illustrating a shell with multiple layers with individual layers having different compositions.

FIG. 1G is an image of an inverse spinel structure of (B³⁺)(A²⁺B³⁺)O₄.

FIG. 2A is a transmission electron microscope image of a magnetite (Fe₃O₄) nanodisc (MND).

FIG. 2B is a transmission electron microscope image of an MND with a CoFe₂O₄ shell, also call a CoFe₂O₄ shell on a nanodisc (CFOND).

FIG. 2C is a plot of X-ray diffraction patterns of CFONDs (upper trace) and MNDs (lower trace).

FIG. 3A shows inverted microscope fluorescent images of hippocampal neurons co-transfected with gCaMP6s (Ca indicator; left), TRPV1 (heat-sensitive ion channel; middle); and their overlap (right).

FIG. 3B shows heat maps representing the fluorescence change of individual neurons during magnetothermal stimulation with CFONDs.

FIG. 3C shows average fluorescence traces of reactive neurons (shading indicates periods when an alternating magnetic field (AMF) is applied to the CFONDs.

FIG. 3D is a plot of temperature versus time for a CFOND solution (again, shading indicates when the AMF on).

FIG. 4A shows a core-shell nanodisc with a polymer coating.

FIG. 4B shows a core-shell nanodisc with a polymer coating with hydrophobic and hydrophilic side chains.

FIG. 4C shows a core-shell nanodisc with the polymer coating of FIG. 4B conjugated to a component.

FIG. 4D shows targeting of a cell with a core-shell nanodisc and the polymer coating of FIG. 4C.

FIG. 4E shows the targeted modulation of an ion channel of an individual cell using a core-shell nanodisc without an applied magnetic field.

FIG. 4F shows the targeted modulation of an ion channel of an individual cell using a core-shell nanodisc with an applied magnetic field.

FIG. 5 shows a plurality of core-shell nanodiscs dispersed in a biocompatible solvent.

FIG. 6 is a graph comparing the specific loss power (SLP) for a conventional MNP, an MND core, and a CFOND measured with both calorimetry (solid bars) and AC magnetometry (diagonal striped bars). The frequency of the calorimetry coil was 152 kHz. The frequence for AC magnetometry was 75 kHz. H₀=35 kA/m.

FIG. 7 is a graph showing the estimated individual particle loss power for a conventional MNP, a MND core, and a CFOND.

FIG. 8 is a graph of SLP for AC magnetometry of an MND core 110 (dotted line) and a core-shell nanodisc 100 (solid line) at a measurement frequency of 75 kHz.

FIG. 9A shows Ca imaging on hippocampal neurons co-transfected with gCaMP6s (Ca indicator; top), TRPV1 (heat-sensitive ion channel; middle), and CFONDS coated with BG-PEG_PMAO-Cye7 (SNAP-tag CFONDS, 0.05 mg/ml; bottom).

FIG. 9B shows a heat map representing the fluorescence change of individual neurons during magnetothermal stimulation with CFONDs.

FIG. 9C shows average fluorescence traces of reactive neurons (shading indicates periods when an alternating magnetic field (AMF) is applied to the CFONDs).

FIG. 10A shows Ca imaging on hippocampal neurons co-transfected with gCaMP6s (Ca indicator; top), TRPV1 (heat-sensitive ion channel; middle), and MNPs coated with BG-PEG_PMAO-Cye7 (SNAP-tag MNPs, 0.05 mg/ml; bottom).

FIG. 10B shows a heat map representing the fluorescence change of individual neurons during magnetothermal stimulation with MNPs.

FIG. 10C shows average fluorescence traces of reactive neurons (shading indicates periods when an alternating magnetic field (AMF) is applied to the MNPs).

### DETAILED DESCRIPTION

Conventional magnetic nanoparticles (MNPs) are typically iron oxide (magnetite) spheres less than 50 nm in diameter that tend to exhibit hysteresis when used for magnetothermal modulation of ion channels. In contrast, inventive MNPs are anisotropic—they are elongated rather than spherical—and have lateral dimensions ranging from about 100 nm to about 550 nm and thicknesses of up to about 50 nm. Inventive MNPs may be oblate (e.g., disk shaped) and/or prolate (e.g., cigar shaped) spheroids. Unlike a conventional MNP, an inventive MNP has a soft magnetic core (e.g., a magnetite core, which has a morphology that may cause an inventive MNP to be shaped like a hexagonal disc) surrounded by a harder magnetic shell (e.g., an AₓFe₃₋ₓO₄ shell, where A is Co, Mn, Ni, Fe, Zn, Mg, or Cu) that may about 3-10 nm thick. Preferably, the magnetic shell is made from a material that is a harder magnetic material than the material of the core to create a higher magnetic anisotropy.

This combination of enhanced shape anisotropy (e.g., hexagonal disc or elongated shape) and magnetic crystalline anisotropy (caused by the spin-exchange coupling effect at the soft-hard magnet interface) increases the hysteresis loop area. Hence, an inventive MNP can generate more heat than a conventional MNP when subjected to a given magnetic field. A single inventive MNP can generate up to 3,000 times more heat than a conventional MNP for the same applied magnetic field. This means that a few inventive MNPs can generate enough heat to modulate an ion channel in a single cell. Since a cell can accept only a limited number of targeting particles (e.g., MNPs) and a single conventional MNP cannot generate much heat, it may not be possible to modulate an ion channel in a single cell with conventional MNPs because the cell cannot accept enough conventional MNPs to reach the desired temperature.

If an inventive MNP is coated with a polymer (e.g., Polyethylene glycol (PEG) and/or Poly(maleic anhydride-alt-1-octadecene (PMAO)), tag (e.g., a SNAP tag-O6-Benzylguanine and/or a HaloTag-HaloTag ligand), dye (e.g., Cy3, 5, 7 and/or Rhodamine), or other coating that can be attached or bonded directly to a particular type of cell or to a particular tag, then it can be used for targeted magnetothermal stimulation and biosignaling. Put differently, a single inventive MNP can be coupled to and used to modulate a cell of a particular type.

Inventive MNPs can be used in injectable neurotechnology, e.g., for treating neurological deficits. Clinical magnetic biosignaling can also be used with medical device technology to stimulate the brain, organs, and the central and peripheral nervous system safely and efficiently while also generating physiological signals. Furthermore, the magnetothermal properties of inventive MNPs enable cell-specific, targeted biosignaling.

### Core-Shell Nanodisc Synthesis

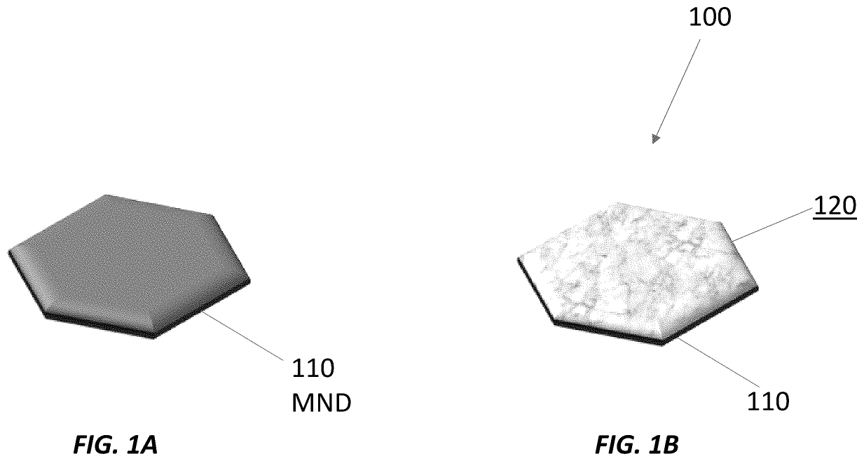

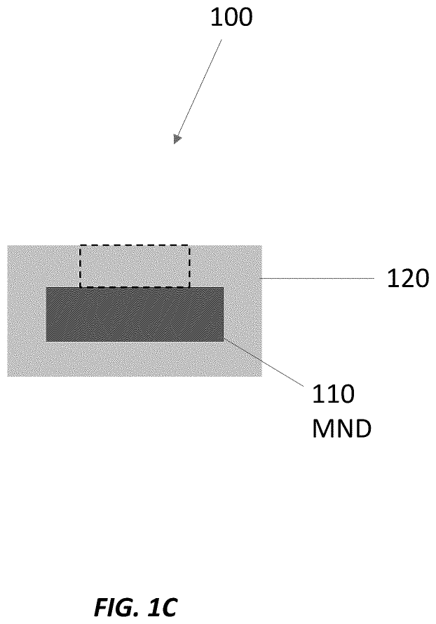

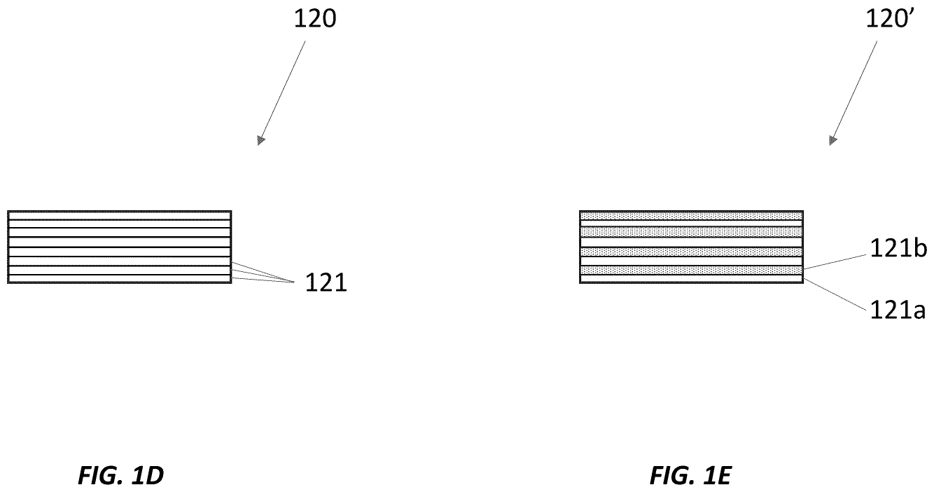

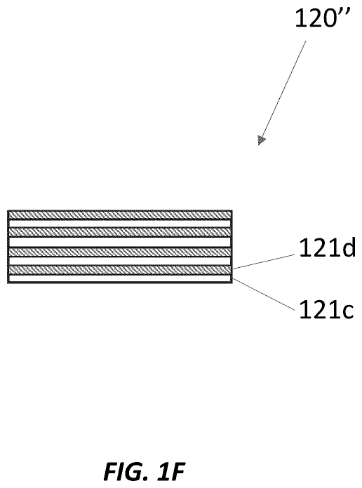

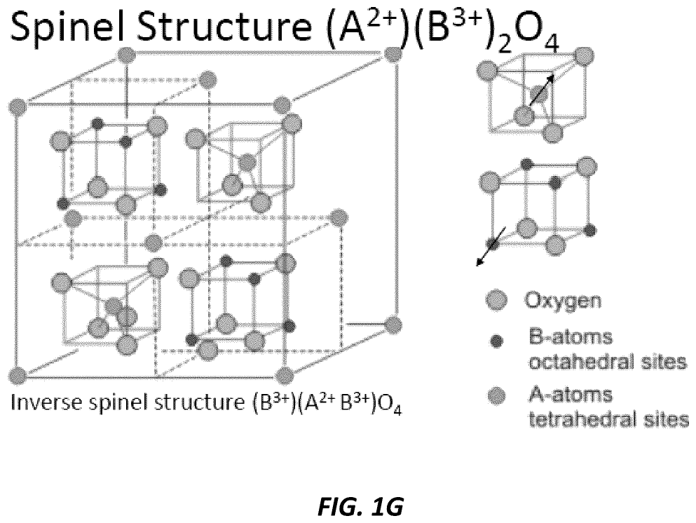

FIGS. 1A and 1B illustrate the components of a core-shell nanodisc 100 (e.g., an inventive MNP). The core-shell nanodisc 100 can be synthesized first by synthesizing a magnetite (Fe₃O₄) nanodisc (MND) core 110 via reduction of hexagonal nanodisc hematite (Fe₂—O₃) and then forming a (inverse) spinel-crystal structured ferrite shell 120 around each MND core 110.

FIG. 1A illustrates an anisotropic (here, hexagonal) MND core 110. The MND core 110 may be made of magnetite (Fe₃O₄). The shape anisotropy of the MND core 110 may include, but is not limited to, oblate (e.g., disc shaped), prolate (e.g., cigar shaped), a 2-dimensional flake, a disc, and/or a 1-dimentional morphology (e.g., a nanorod). The MND core 110 can be made by first heating FeCl₃, sodium acetate, ethanol, and water in an autoclave reactor to generate hematite nanodiscs. Tuning the amount of water in the solution tunes the aspect ratio of the hematite nanodiscs, with 6-9% water producing hexagonal hematite nanodiscs. Hematite nanodiscs prepared with higher water concentrations (e.g., greater than 6-9%) may be more isotropic in shape. Hematite nanodiscs prepared with less than 6% water may have a larger diameter and/or a non-uniform morphology. The hematite nanodiscs are washed in deionized water, dried, resuspended in trioctylamine and oleic acid, and heated in a hydrogen atmosphere to be converted to magnetite. Reducing the hematite nanodiscs in a hydrogen atmosphere yields complete conversion of nonmagnetic hematite into a MND core 110 while maintaining the hematite nanodiscs' anisotropic (e.g., hexagonal) geometry.

FIG. 1B illustrates a core-shell nanodisc 100 including a MND core 110 and a shell 120 surrounding the MND core 110. The shell 120 may be an (inverse) spinel-crystal structured ferrite shell 120. The shell 120 may be made of AₓFe₃₋ₓO₄ (A=Co, Mn, Ni, Fe, Zn, Mg, or Cu). The shell 120 surrounding the MND core 110 can be formed by hetero nucleation and growth of AₓFe₃₋ₓO₄ (A=Co, Mn, Ni, Fe, Zn, Mg, or Cu) using heat-up colloidal synthesis based on acetylacetone (acac) precursors. The composition of the AₓFe₃₋ₓO₄ shell 120 depends on the ratio of the precursors. For example, CoₓFe₃₋ₓO₄ can be synthesized with x mol of Co(acac)₂ and (3−x) mol of Fe(acac)₃, MnₓFe₃₋ₓO₄ can be synthesized with x mol of Mn(acac)₂ and (3−x) mol of Fe(acac)₃, NiₓFe₃₋ₓO₄ can be synthesized with x mol of Ni(acac)₂ and (3−x) mol of Fe(acac)₃, FeₓFe₃₋ₓO₄ can be synthesized with x mol of Fe(acac)₂ and (3−x) mol of Fe(acac)₃, ZnₓFe₃₋ₓO₄ can be synthesized with x mol of Zn(acac)₂ and (3−x) mol of Fe(acac)₃, MgₓFe₃₋ₓO₄ can be synthesized with x mol of Mg(acac)₂ and (3−x) mol of Fe(acac)₃, and CuₓFe₃₋ₓO₄ can be synthesized with x mol of Cu(acac)₂ and (3−x) mol of Fe(acac)₃. The solution for the heat-up colloidal synthesis may include Diphenyl ether 20 mL, Oleylamine 1.97 mL, Oleic Acid 1.90 mL, and the MND cores 110. Using a condenser, N₂ inlet, and magnet stirring at 800 rpm, the heat-up colloidal synthesis process is as follows:
(1) Stir for 30 minutes at 100° C. with the vacuum pump on;
(2) Increase temperature to 200° C. at 7° C./minute with the vacuum pump off;
(3) Stir for 30 minutes at 200° C. under N₂ flow;
(4) Increase temperature to 230° C. at 7° C./minute speed under N₂ flow;
(5) Stir for 30 minutes to 2 hours at 230° C. under N₂ flow; and
(6) Cool to room temperature and wash, five times, with ethanol and hexane solution while centrifuging at 9000 rpm for 7 minutes each time.

In the colloidal synthesis process, the speed of the temperature increase may vary depending on the type of temperature controller. Additionally, step 3 above may be optional in the synthesis process. Furthermore, the time for step 5 may vary from 30 minutes to 2 hours depending on the thickness of the shell 120.

FIG. 1C illustrates a cross-section of the core-shell nanodisc 100 including a MND core 110 and a shell 120 surrounding the MND core 110. As shown in FIG. 1C, the shell 120 may completely surround the MND core 110. The shell 120 may include a plurality of layers.

FIGS. 1D and 1E illustrate shells 120 and 120′, each with a plurality of layers 121. The thickness of the magnetic shell 120 can be controlled by repeating the heat-up colloidal synthesis process described immediately above, with each time through the process yielding another layer 121 of AₓFe₃₋ₓO₄. FIG. 1D illustrates a shell 120 with multiple layers 121 (e.g., multiple layers of AₓFe₃₋ₓO₄). For example, repeating the heat-up colloidal synthesis process three times yields a (inverse) spinel-crystal structured ferrite shell 120 that is about 5 nm thick (e.g., 1.67 nm per layer). There is no upper limit in the thickness of the shell 120, though thicker shells 120 may increase the magnetic crystalline anisotropy and decrease the shape anisotropy. Increasing the thickness of the shell 120 beyond 0 nm may decrease the shape anisotropy of the shell 120. The magnetic crystalline anisotropy may increase according to the enhancement of the mass of the materials with the larger intrinsic magnetic crystalline anisotropy.

If desired, the composition of the shell's layers 121 can change, e.g., to have a stoichiometry that varies with radius from the center of the MND core 110. For example, the shell 120′ in FIG. 1E includes a first layer 121a with a first stoichiometry and a second layer 121b with a second stoichiometry that is different from the first stoichiometry. Alternatively, the composition of the shell's layers 121 may also change to have different compositions. For example, the shell 120″ in FIG. 1F includes a first layer 121c with a first composition (e.g., Aₓ-Fe₃₋ₓO₄ (A=Co, Mn, Ni, Fe, Zn, Mg, or Cu)) and a second layer 121d with a second composition (e.g., AₓFe₃₋ₓO₄ (where A=Co, Mn, Ni, Fe, Zn, Mg, or Cu and)) that is different from the first composition (e.g., where A in the first layer 121c and A in the second layer 121d are different).

FIG. 1G illustrates the inverse spinel structure of a (A²⁺)(B³⁺)₂O₄ ferrite shell 120 of the core-shell nanodisc 100 shown in FIG. 1B where B may be Fe and A may be Co, Mn, Ni, Fe, Zn, Mg, or Cu. For example, the shell 120 may have the formula AₓFe₃₋ₓO₄ where A=Co, Mn, Ni, Fe, Zn, Mg, or Cu.

The outer dimensions of a core-shell nanodisc 100 are the sums of the MND core's 110 outer dimensions and the shell 120 thickness. The MND core's 110 diameter can be regulated during synthesis of the hematite nanodiscs by adjusting the amount of water used for the hydrothermal process. Typically, each MND core 110 is a hexagonal disc about 20-50 nm thick with short diagonals (minimum lateral dimensions) of between about 100 nm and about 300 nm and long diagonals (maximum lateral dimensions) between about 170 and about 550 nm.

The spin exchange coupling effect and the shape anisotropy effect may lead to the generation of high specific loss power (SLP) for core-shell nanodiscs 100 under an alternating magnetic field (e.g., 1270-1980 W/g for an inventive core-shell nanodisc 100 versus 700-1210 W/g for a conventional MNP at 75 kHz 35 kA/m alternating magnetic field). The SLP represents the electromagnetic power lost per mass unit of the MNP. The SLP is the frequency multiplied by the area of the hysteresis loop of magnetization. The area of the hysteresis loop is determined by the saturation magnetization and the coercivity. A core-shell nanodisc 100 with a maximum diameter (long diagonal) of about 250 nm generates a high saturation magnetization (e.g., 110-120 emu/g). The shape anisotropy of a core-shell nanodisc 100 and the spin-exchange coupling effect at the interface between the magnetic core 110 and magnetic shell 120 yields relatively high coercivity (e.g., 650-700 Oe).

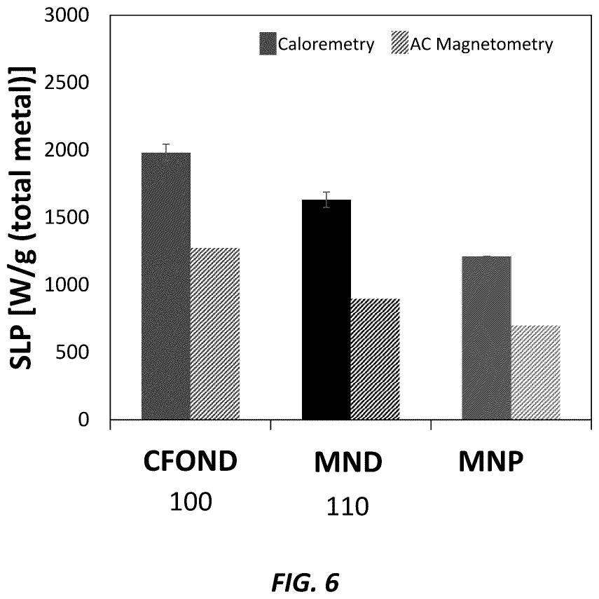

FIG. 6 is a graph comparing the SLP for a conventional MNP, the MND core 110, and a core-shell nanodisc 100 for both calorimetry (solid bars) and AC magnetometry (diagonal striped bars). As shown in FIG. 6, both the MND core 110 and the core-shell nanodisc 100 have a higher SLP than a conventional MNP. The SLP is calculated using equation 1 below:

$$Specific Loss Power ( SLP ) = \frac{Cw}{m} \frac{Δ T}{Δ t} , \qquad Equation 1$$

where C_{w}=Specific heat capacity of water,

$$4.184 ( \frac{J}{ml \cdot K} ) ,$$

ΔT/Δt=Temperature increase under AMF, and m=Concentration of MNPs diluted in water (g/ml_{[metal]}).

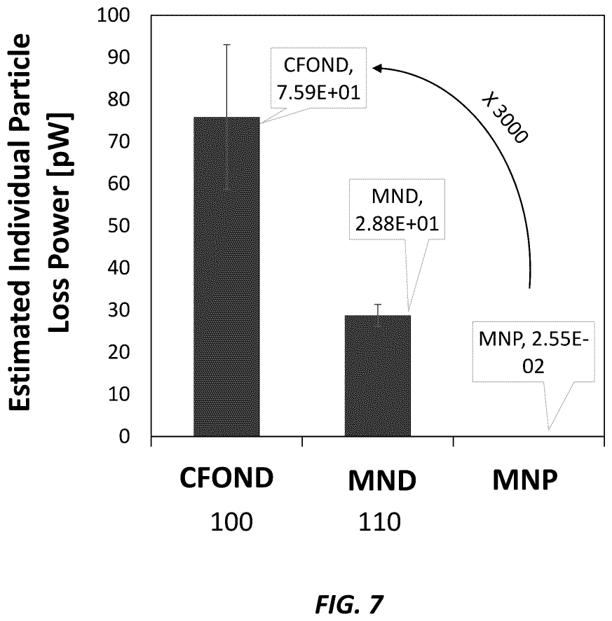

FIG. 7 is a graph showing the estimated individual particle loss power for a conventional MNP, a MND core 110, and a core-shell nanodisc 100. As shown in FIG. 7, a core-shell nanodisc 100 may be able to generate up to 3,000 times more heat than a conventional MNP for the same applied magnetic field. As a result, a single core-shell nanodisc 100 may be able to generate enough heat to modulate an ion channel in a single cell.

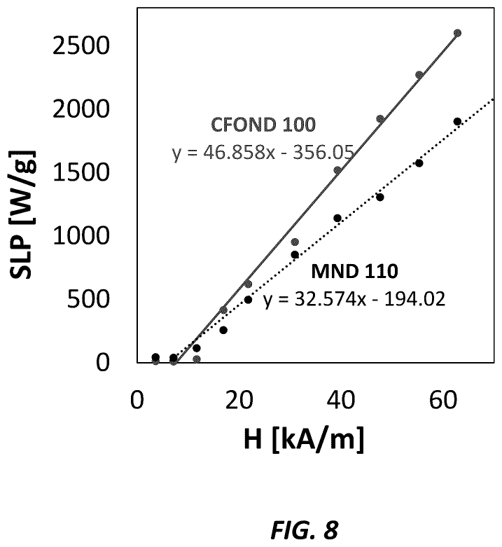

FIG. 8 is a graph of SLP for AC magnetometry of a MND core 110 (dotted line) and a CFOND 100 (solid line). It shows that the SLP of a CFOND grows with AC field amplitude at a faster rate than the SLP of an MND.

Single-Particle Magnetothermal Neural Modulation with CoFe₂O₄—Fe₃O₄ Core-Shell Nanodiscs

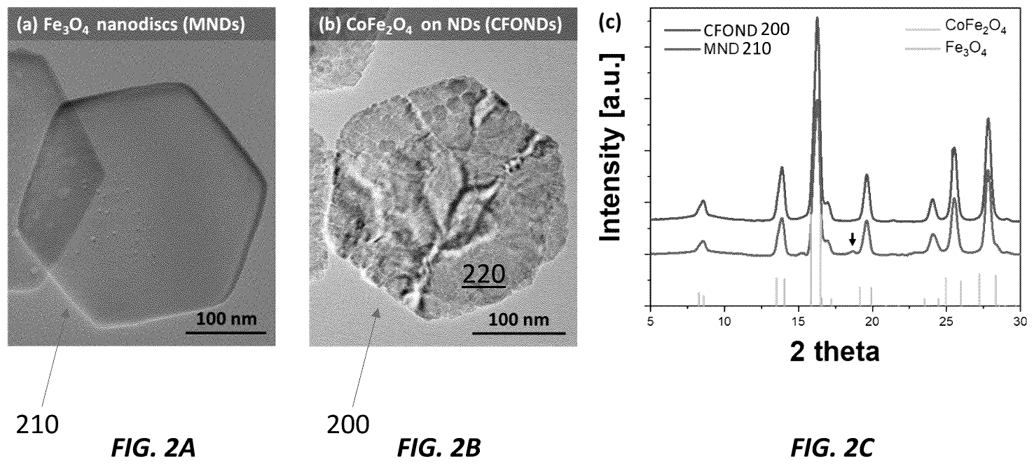

FIG. 2A shows a magnetite nanodisc (MND) 210 made from 1 mol of Co(acac)₂ and 2 mol of Fe(acac)₃ as precursors. FIG. 2B shows a core-shell nanodisc 200. The core-shell nanodisc 200 may include a magnetite core 210 (e.g., one of the MNDs 210 of FIG. 2A). The core-shell nanodisc 200 may be coated with a CoFe₂O₄ shell 220—a CoFe₂O₄ shell 220 on nanodisc (e.g., a CFOND core-shell nanodisc 200). The CoFe₂O₄ shell 220 may be formed on the MND core 210 using heat-up colloidal synthesis with a solution that includes 20 mL of diphenyl ether, 1.97 mL of oleylamine, 1.90 mL of Oleic Acid, and the MND cores 210. The MND cores 210 were stored in a hydrophobic solvent, such as chloroform or hexane, before the heat-up colloidal synthesis. The solvents were evaporated, and the MND cores 210 were dissolved in the diphenyl ether. If there is any MND-dispersing solvent (e.g., chloroform and/or hexane) in the heat-up synthesis solution, it may not be possible to heat the heat-up colloidal synthesis solution to the desired temperature. MND-dispersing solvent can also cause unexpected and potentially undesired side reactions during heat-up colloidal synthesis.

FIG. 2C shows X-ray diffraction patterns of the MND core 210 (lower trace) and the CFOND core-shell nanodisc 200 (upper trace) in FIGS. 2A and 2B, respectively, as well as for magnetite and CoFe₂O₄ (peaks along the x axis). The X-ray diffraction patterns indicate successful formation of the CFOND core-shell nanodisc 200, as a result in part to careful control of the temperature during the heat-up colloidal synthesis process.

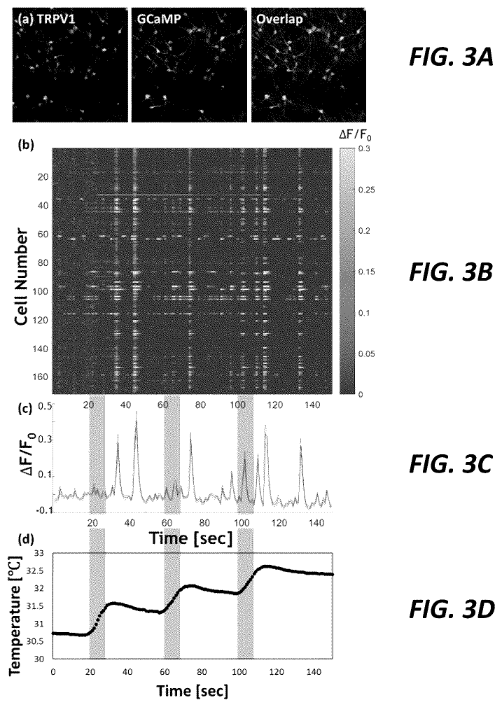

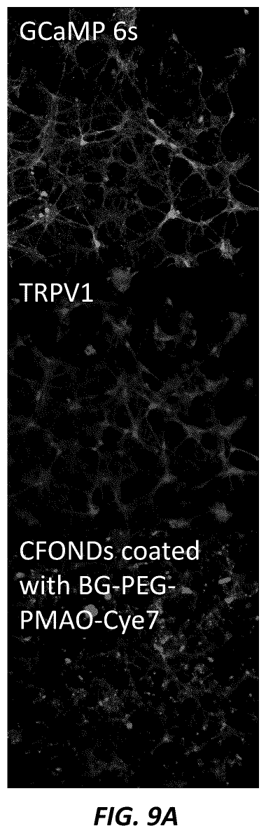

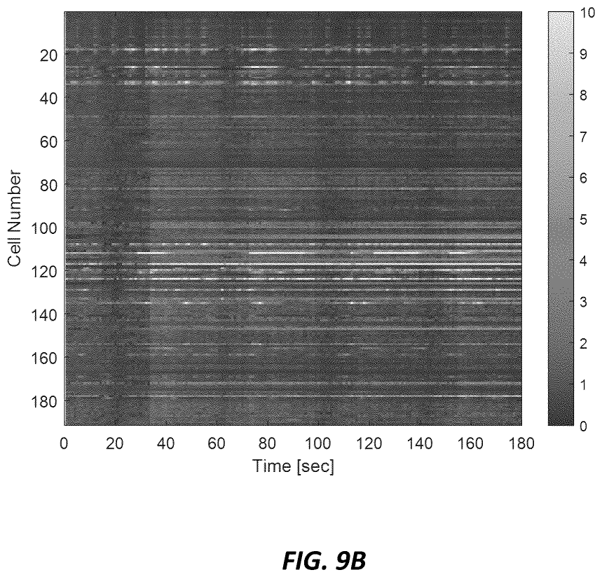

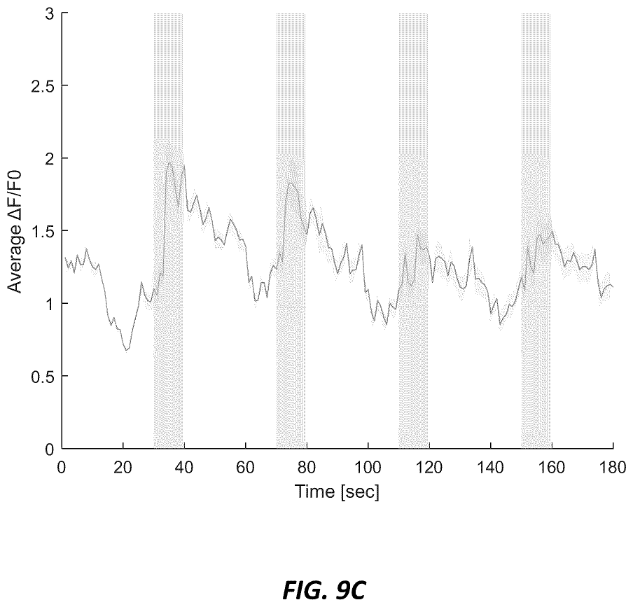

FIGS. 3A-3D and 9A-9C illustrate how CFOND core-shell nanodiscs 200, like the one shown in FIG. 2B, can be exploited for modulating neurons with heat-sensitive ion channels. More specifically, FIGS. 3A-3D and 9A-9C show that the magnetothermal membrane depolarization with the CoFe₂O₄—Fe₃O₄ core-shell nanodisc 200 can evoke action potential trains in primary hippocampal neurons expressing transient receptor potential cation channel subfamily V member 1 (TRPV1). FIG. 3A shows fluorescence images of the hippocampal neurons co-transfected with gCaMP6s, which is a Ca indicator (FIG. 3A, middle) and TRPV1, which is a heat-sensitive ion channel (FIG. 3A, left). The right side of FIG. 3A shows the overlap between gCaMP6s and TRPV1. FIG. 9A shows Ca imaging on hippocampal neurons co-transfected with gCaMP6s (Ca indicator; top), TRPV1 (heat-sensitive ion channel; middle), and CFONDS coated with BG-PEG_PMAO-Cye7 (SNAP-tag CFONDS, 0.05 mg/ml; bottom).

The co-transfected hippocampal neurons were thermally stimulated using magnetothermal CFONDs 200 subject to alternating magnetic field. FIG. 3B and FIG. 9B show heat maps representing fluorescence emitted by individual hippocampal neurons during magnetothermal stimulation with CFONDs 200. FIGS. 3C and 3D are plots of the normalized fluorescence intensity and temperature for a CFOND 200 solutions, respectively, versus time, where shading indicates periods when the alternating magnetic field was applied to the CFONDs 200. FIG. 9C is a plot of the normalized fluorescence intensity for a CFOND 200 solution versus time where shading indicates periods when the alternating magnetic field was applied to the CFONDs 200.

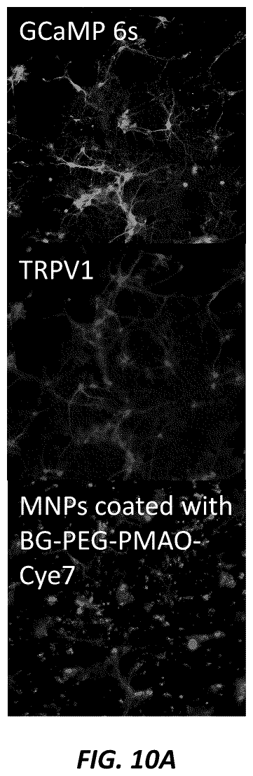

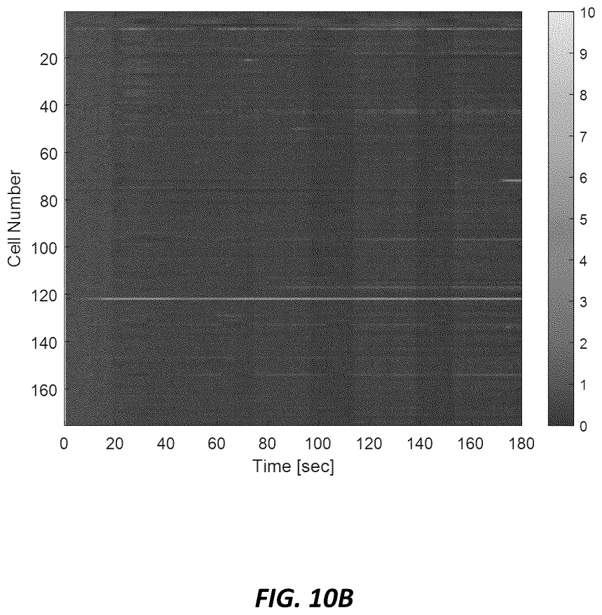

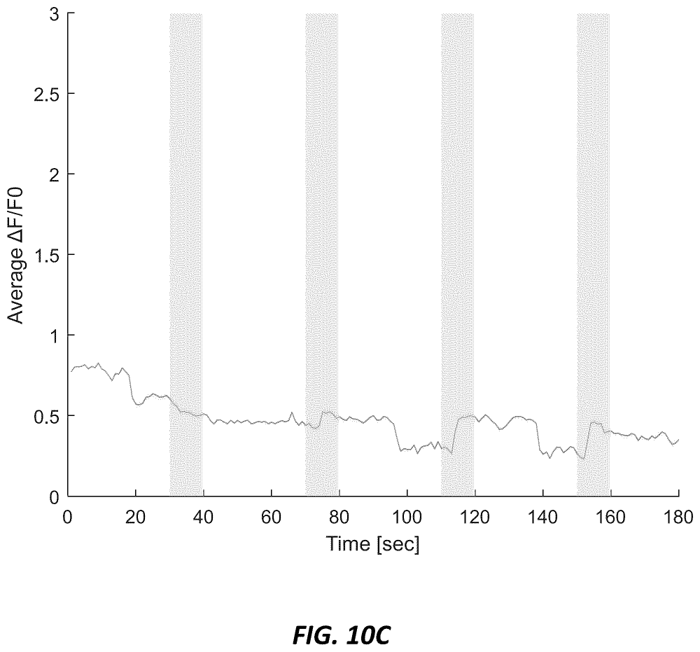

In comparison, FIGS. 10A-10C illustrate modulating neurons with heat-sensitive ion channels with conventional MNPs. FIG. 10A shows Ca imaging on hippocampal neurons co-transfected with gCaMP6s (Ca indicator; top), TRPV1 (heat-sensitive ion channel; middle), and MNPs coated with BG-PEG_PMAO-Cye7 (SNAP-tag MNPs, 0.05 mg/ml; bottom). The co-transfected hippocampal neurons were thermally stimulated using conventional MNPs subject to alternating magnetic field. FIG. 10B shows heat maps representing fluorescence emitted by individual hippocampal neurons during magnetothermal stimulation with conventional MNPs. FIG. 10C is a plot of the normalized fluorescence intensity for a conventional MNPs solution versus time where shading indicates periods when the alternating magnetic field was applied to the conventional MNPs.

The alternating magnetic field for the magnetothermal transduction in FIGS. 3C, 3D, 9C, and 10C was at an amplitude of 35 kA/m and a frequency of 152 Hz. The neural activity was recorded with the GcaMP6s temporal fluorescence traces. Waves of Ca²⁺ spikes in FIG. 3C were repeatedly induced by field pulses only in TRPV1⁺ neurons in the presence of CFONDs 200. And FIG. 3D shows the temperature of the CFOND 200 solution increased in response to the alternating magnetic field. Compared to the results for conventional MNPS (shown in FIGS. 10A-10C), the results of FIGS. 3A-3D and 9A-9B show that CFONDs 200 next to neurons may generate enough heat to open heat-sensitive ion channels and that a single CFOND 200 may be used for magnetothermal neural modulation with an appropriate tag or coating for bonding to the CFOND 200 to a target cell.

Generating Bio-Readable Magnetothermal Signals with Core-Shell Nanodiscs 100

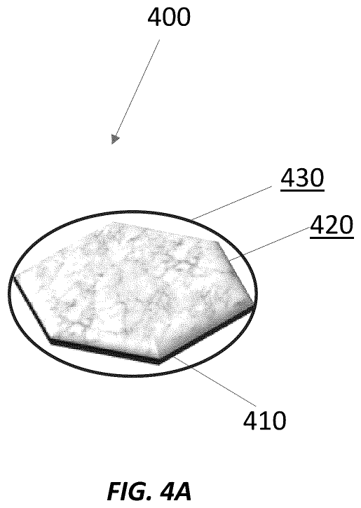

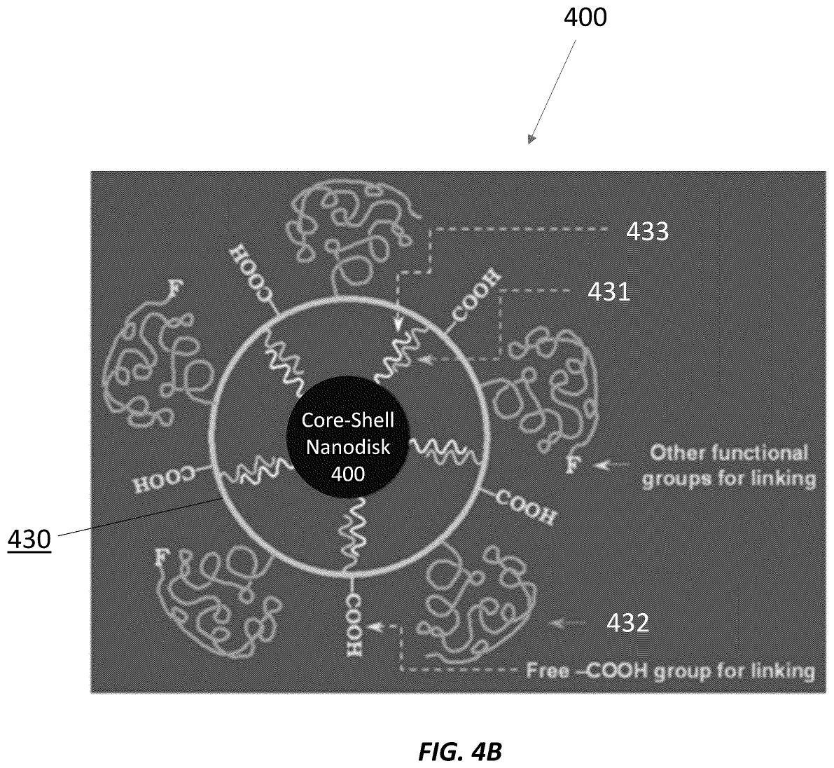

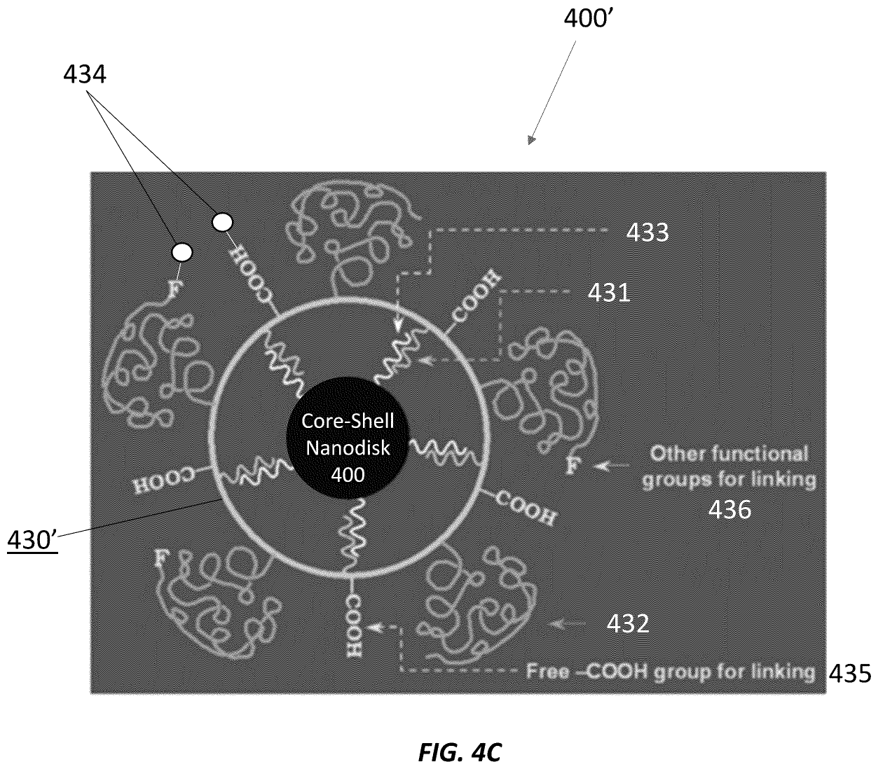

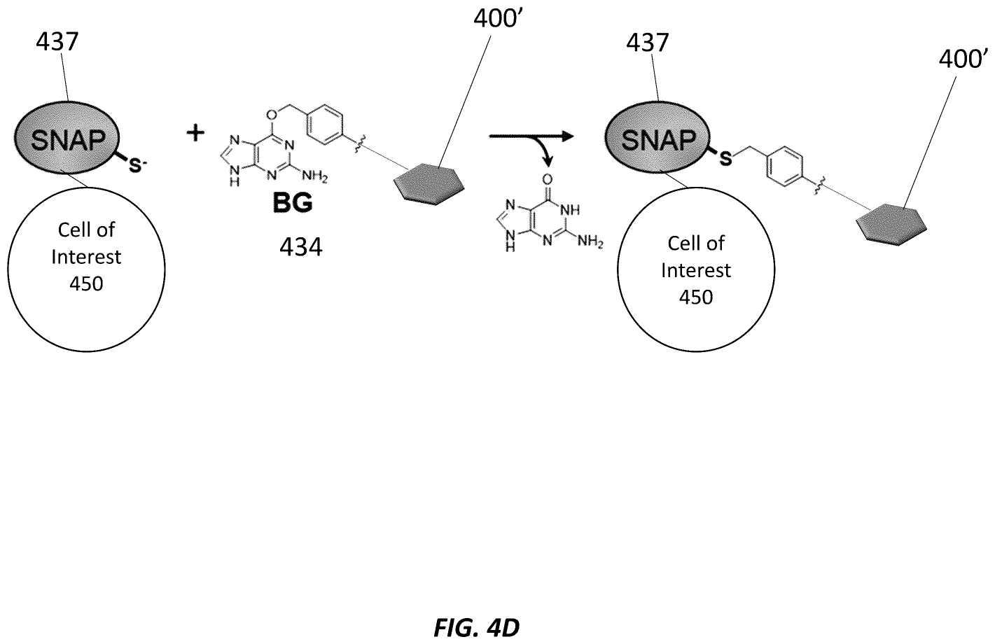

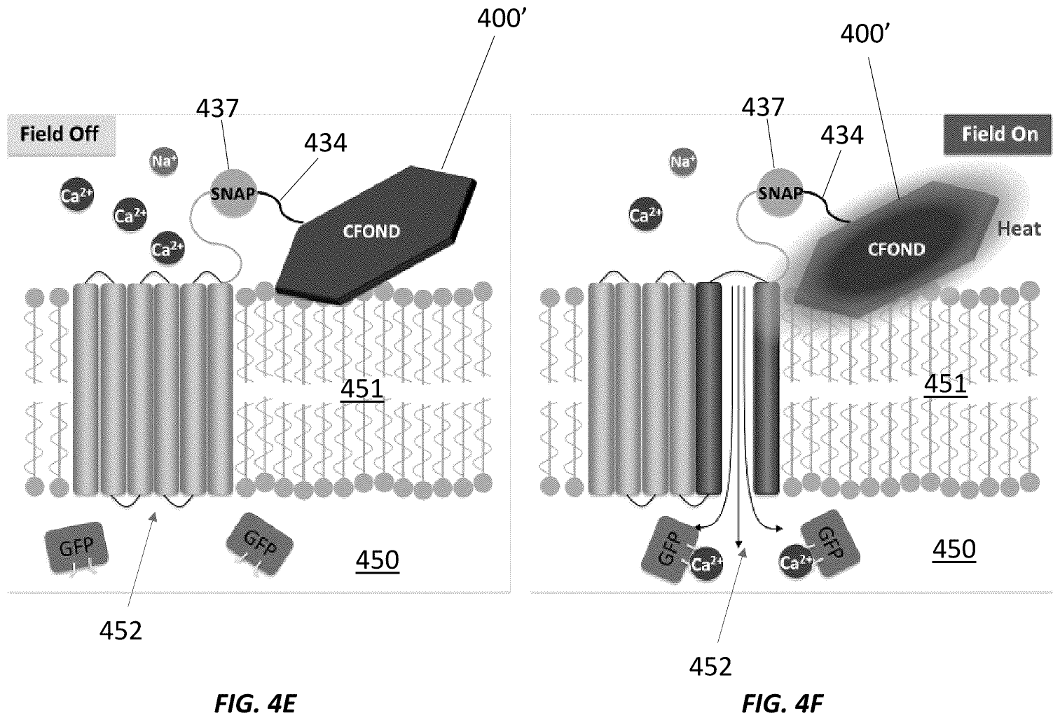

FIG. 4A illustrates a core-shell nanodisc 400 with a coating 430. The core-shell nanodisc may include an MND core 410 and a shell 420 as described above. The core-shell nanodisc 400 may also include a coating 430. The coating 430 may help to disperse the core-shell nanodisc 400 in a biocompatible solvent, such as phosphate-buffered saline (PBS), the hydrophobic surfaces of the nanodisc 400 may be transited to be hydrophilic.

FIG. 4B illustrates the core-shell nanodisc 400 and coating 430 with a plurality of side chains. The coating 430 may include at least one hydrophobic side chain 431 and at least one hydrophilic side chain 432. Coating the core-shell nanodisc 400 with a polymer coating 430 having hydrophobic side chains 431 and hydrophilic side chains 432 may cause the hydrophobic side chains 431 and hydrophilic side chains 432 to direct themselves toward the nanoparticles and the solvent, respectively, and may yield a coated core-shell nanodisc 400 with hydrophilic surfaces. Suitable polymers may include, but are not limited to, Polysarcosine (pSar), Poly(thioglycidyl glycerol), XTENylation, Zwitterionic polymers (e.g., poly(methacryloyloxylethyl phosphorylcholine), poly(sulfobetaine methacrylate), and/or poly(sulfobetaineacrylamide)), Poly(amino acid) based lipopolymers (e.g., poly(O-alanine), poly(lysine), poly(γ-glutamic acid), cyanophycin, poly(hydroxyethyl-1-asparagine), and/or poly(hydroxyethyl-1-glutamine), hydrophilic polymers (e.g., acrylics, epoxies, polyethylene, polystyrene, polyvinylchloride, polytetrafluorethylene, polydimethylsiloxane, polyesters, and/or polyurethanes), PEG, PMAO, and/or PEG-PMAO. For example, when the polymer is PEG-PMAO the PEG may provide the hydrophilic side chains and the PMAO may provide the hydrophobic side chains. The core-shell nanodisc 400 may also have a hydrophobic side chain or ligand 433 on the surface of the core-shell nanodisc 400 that may interact with the hydrophobic side chain 431 of the polymer coating 430.

FIG. 4C illustrates a core-shell nanodisc 400′ and coating 430′. The coating 430′ may be conjugated with one or more component(s) 434. The component 434 may be a tag (e.g., a SNAP tag-O6-Benzylguanine and/or a HaloTag-HaloTag ligand), dye (e.g., Cy3, 5, 7 and/or Rhodamine) or other component that can be attached or bonded directly to a particular type of cell or to a particular tag to enable the core-shell nanodisc 400′ to be used for targeted magnetothermal stimulation and biosignaling. The coating 430′ may include a free —COOH group 435 and/or a functional group (F) 436 to enable linking with a tag, dye, and/or other component. For example, rhodamine 123 and/or Cy7 amine may be attached to a —COOH group 435 of the coating 430′. Instead of, or in addition to, rhodamine 123 and/or Cy7, a tag may be attached to the functional group (F) 436 of the coating 430′.

FIG. 1D illustrates the targeting of a cell 450 with the core-shell nanodisc 400′. The core-shell nanodisc 400′ may include coating 430′ as described above (not shown in FIGS. 1D-1F). The coating 430′ may include one or more component(s) 434 as described above. If the polymer coating 430′ is conjugated with a component 434 enabling the formation of a bond with materials pairable with a corresponding tag 437 in the targeting area, it may become possible to generate specific or targeted local stimulation with the magnetothermal nanodiscs 400′. The tag 437 can be expressed at the targeting area with transgenesis, which can covalently bond to the component 434 (e.g., a synthetic ligand) conjugated with the polymer coating 430′ on a core-shell nanodisc 400′ as shown in FIG. 4D.

FIGS. 4E and 4F illustrate the targeted modulation of a cell 450 using magnetic transduction. Injecting core-shell nanodisc(s) 400′ in a bio-compatible solution into a body part where temperature-based bio-signal is desired may make that body part sensitive to magnetothermal stimulation. Magnetothermal transduction with core-shell nanodiscs 400′ may enable a single core-shell nanodisc 400′ to generate enough heat for stimulating (i.e., opening) a heat-sensitive ion channel 452 in a cell membrane 451 of a cell 450 under an appropriate alternating magnetic field as shown in FIGS. 4E and 4F. As described above, the core-shell nanodisc 400′ may include the coating 430′ (not shown in FIGS. 4E and 4F) and the coating 430′ may include one or more component(s) 434 as described above. The one or more components 434 may enable the formation of a bond with materials pairable with a corresponding tag 437 in the target area.

Instead of, or in addition to, the core-shell nanodisc 400 or 400′, the MND core 410 may also be used for targeted modulation of the cell 450. In this embodiment, the MND core 410 may be coated with coating 430 or 430′ as described above. The coating 430 may include at least one hydrophobic side chain 431 and at least one hydrophilic side chain 432. The MND core 410 may also have a hydrophobic side chain or ligand 433 on the surface of the core-shell nanodisc 400 that may interact with the hydrophobic side chain 431 of the polymer coating 430 or 430′. The coating 430′ may be conjugated with one or more component(s) 434 as described above that may enable the formation of a bond with materials pairable with a corresponding tag 437 in the target area.

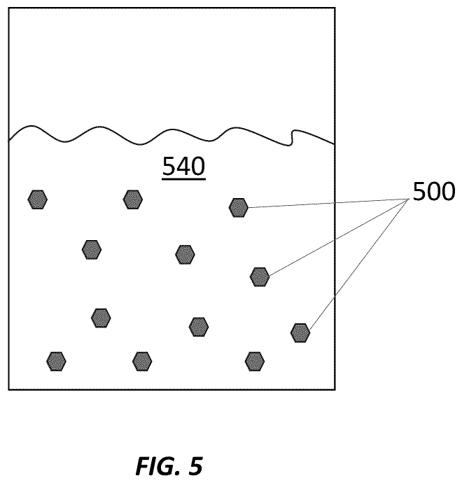

FIG. 5 illustrates a plurality of core-shell nanodiscs 500 dispersed in a solvent 540. The solvent 540 may be a biocompatible solvent, such as PBS. The core-shell nanodiscs 500 may each include an MND core and a shell as described above. The core-shell nanodiscs 500 may also be coated with a with a polymer coating (e.g., PEG-PMAO) as described above. The polymer coating may also be conjugated with a component (e.g., a synthetic ligand) to enable specific or targeted local stimulation as described above.

### CONCLUSION

While various inventive embodiments have been described and illustrated herein, those of ordinary skill in the art will readily envision a variety of other means and/or structures for performing the function and/or obtaining the results and/or one or more of the advantages described herein, and each of such variations and/or modifications is deemed to be within the scope of the inventive embodiments described herein. More generally, those skilled in the art will readily appreciate that all parameters, dimensions, materials, and configurations described herein are meant to be exemplary and that the actual parameters, dimensions, materials, and/or configurations will depend upon the specific application or applications for which the inventive teachings is/are used. Those skilled in the art will recognize or be able to ascertain, using no more than routine experimentation, many equivalents to the specific inventive embodiments described herein. It is, therefore, to be understood that the foregoing embodiments are presented by way of example only and that, within the scope of the appended claims and equivalents thereto, inventive embodiments may be practiced otherwise than as specifically described and claimed. Inventive embodiments of the present disclosure are directed to each individual feature, system, article, material, kit, and/or method described herein. In addition, any combination of two or more such features, systems, articles, materials, kits, and/or methods, if such features, systems, articles, materials, kits, and/or methods are not mutually inconsistent, is included within the inventive scope of the present disclosure.

Also, various inventive concepts may be embodied as one or more methods, of which an example has been provided. The acts performed as part of the method may be ordered in any suitable way. Accordingly, embodiments may be constructed in which acts are performed in an order different than illustrated, which may include performing some acts simultaneously, even though shown as sequential acts in illustrative embodiments.

All definitions, as defined and used herein, should be understood to control over dictionary definitions, definitions in documents incorporated by reference, and/or ordinary meanings of the defined terms.

The indefinite articles “a” and “an,” as used herein in the specification and in the claims, unless clearly indicated to the contrary, should be understood to mean “at least one.”

The phrase “and/or,” as used herein in the specification and in the claims, should be understood to mean “either or both” of the elements so conjoined, i.e., elements that are conjunctively present in some cases and disjunctively present in other cases. Multiple elements listed with “and/or” should be construed in the same fashion, i.e., “one or more” of the elements so conjoined. Other elements may optionally be present other than the elements specifically identified by the “and/or” clause, whether related or unrelated to those elements specifically identified. Thus, as a non-limiting example, a reference to “A and/or B”, when used in conjunction with open-ended language such as “comprising” can refer, in one embodiment, to A only (optionally including elements other than B); in another embodiment, to B only (optionally including elements other than A); in yet another embodiment, to both A and B (optionally including other elements); etc.

As used herein in the specification and in the claims, “or” should be understood to have the same meaning as “and/or” as defined above. For example, when separating items in a list, “or” or “and/or” shall be interpreted as being inclusive, i.e., the inclusion of at least one, but also including more than one, of a number or list of elements, and, optionally, additional unlisted items. Only terms clearly indicated to the contrary, such as “only one of” or “exactly one of,” or, when used in the claims, “consisting of,” will refer to the inclusion of exactly one element of a number or list of elements. In general, the term “or” as used herein shall only be interpreted as indicating exclusive alternatives (i.e., “one or the other but not both”) when preceded by terms of exclusivity, such as “either,” “one of,” “only one of,” or “exactly one of” “Consisting essentially of,” when used in the claims, shall have its ordinary meaning as used in the field of patent law.

As used herein in the specification and in the claims, the phrase “at least one,” in reference to a list of one or more elements, should be understood to mean at least one element selected from any one or more of the elements in the list of elements, but not necessarily including at least one of each and every element specifically listed within the list of elements and not excluding any combinations of elements in the list of elements. This definition also allows that elements may optionally be present other than the elements specifically identified within the list of elements to which the phrase “at least one” refers, whether related or unrelated to those elements specifically identified. Thus, as a non-limiting example, “at least one of A and B” (or, equivalently, “at least one of A or B,” or, equivalently “at least one of A and/or B”) can refer, in one embodiment, to at least one, optionally including more than one, A, with no B present (and optionally including elements other than B); in another embodiment, to at least one, optionally including more than one, B, with no A present (and optionally including elements other than A); in yet another embodiment, to at least one, optionally including more than one, A, and at least one, optionally including more than one, B (and optionally including other elements); etc.

In the claims, as well as in the specification above, all transitional phrases such as “comprising,” “including,” “carrying,” “having,” “containing,” “involving,” “holding,” “composed of,” and the like are to be understood to be open-ended, i.e., to mean including but not limited to. Only the transitional phrases “consisting of” and “consisting essentially of” shall be closed or semi-closed transitional phrases, respectively, as set forth in the United States Patent Office Manual of Patent Examining Procedures, Section 2111.03.

1. A method of making an anisotropic magnetothermal nanoparticle, the method comprising:
forming a magnetite nanodisc via reduction of hexagonal nanodisc hematite; and
growing AₓFe₃₋ₓO₄ on the magnetite nanodisc to form the anisotropic magnetothermal nanoparticle, where A is one of Co, Mn, Ni, Fe, Zn, Mg, or Cu.

2. The method of claim 1, wherein forming the magnetite nanodisc via reduction of hexagonal nanodisc hematite comprises controlling a percentage of water in the reduction.

3. The method of claim 2, wherein the percentage of water is 6-9%.

4. The method of claim 1, wherein the magnetite nanodisc has a maximum lateral dimension of about 170 nm to about 550 nm, a minimum thickness of at least about 20 nm, and a maximum thickness of up to about 50 nm.

5. The method of claim 1, wherein growing the AₓFe₃₋ₓO₄ on the magnetite nanodisc comprises growing a plurality of layers of the AₓFe₃₋ₓO₄ on the magnetite nanodisc.

6. The method of claim 1, wherein growing the AₓFe₃₋ₓO₄ on the magnetite nanodisc comprises growing the AₓFe₃₋ₓO₄ to a thickness of about 3 nm to about 10 nm.

7. The method of claim 1, further comprising:
coating the anisotropic magnetothermal nanoparticle with a polymer having hydrophobic and hydrophilic side chains.

8. The method of claim 7, further comprising:
conjugating the polymer with a component enabling formation of a bond with a material pairable with a tag for tissue to be heated with magnetothermal nanoparticles.

9. The method of claim 7, wherein the anisotropic magnetothermal nanoparticle is one of a plurality of anisotropic magnetothermal nanoparticles, and further comprising:
dispersing the plurality of anisotropic magnetothermal nanoparticles in a biocompatible solvent.

10. An anisotropic magnetothermal nanoparticle comprising:
a magnetite core having a maximum lateral dimension of about 170 nm to about 550 nm, a minimum thickness of at least about 20 nm, and a maximum thickness of up to 50 nm; and
an AₓFe₃₋ₓO₄ coating on the magnetite core, where A is one of Co, Mn, Ni, Fe, Zn, Mg, or Cu.

11. The anisotropic magnetothermal nanoparticle of claim 10, wherein the AₓFe₃₋ₓO₄ coating has a thickness of about 5 nm.

12. The anisotropic magnetothermal nanoparticle of claim 10, further comprising:
a polymer outer layer disposed on the AₓFe₃₋ₓO₄ coating and having hydrophobic side chains oriented toward the AₓFe₃₋ₓO₄ coating and hydrophilic side chains oriented away from the AₓFe₃₋ₓO₄ coating.

13. The anisotropic magnetothermal nanoparticle of claim 12, further comprising:
a component conjugated with the polymer outer layer and enabling formation of a bond with a material pairable with a tag for tissue to be heated with the anisotropic magnetothermal nanoparticle.

14. The anisotropic magnetothermal nanoparticle of claim 10, wherein A is Co.

15. The anisotropic magnetothermal nanoparticle of claim 10, wherein the AₓFe₃₋ₓO₄ coating comprises a plurality of layers.

16. The anisotropic magnetothermal nanoparticle of claim 15, wherein the plurality of layers comprising a first layer having a first stoichiometry and a second layer having a second stoichiometry different than the first stoichiometry.

17. The anisotropic magnetothermal nanoparticle of claim 10, wherein the magnetite core is hexagonal.

18. The anisotropic magnetothermal nanoparticle of claim 10, wherein the anisotropic magnetothermal nanoparticle has a specific loss power of about 1270 to about 1980.

19. An anisotropic magnetothermal nanoparticle comprising:
a soft magnetic core having an anisotropic shape; and
a hard magnetic coating on the soft magnetic core providing magnetic crystalline anisotropy via spin-exchange coupling effects at an interface between the soft magnetic core and the hard magnetic coating.

20. The anisotropic magnetothermal nanoparticle of claim 19, wherein the anisotropic magnetothermal nanoparticle has a specific loss power of about 1270 to about 1980.
